(19) United States
(12) Patent Application Publication
(10) Pub. No.: US 2010/0110056 A1
(43) Pub. Date: May 6, 2010

(54) CONNECTOR, CONNECTOR ASSEMBLY, AND DISPLAY APPARATUS HAVING THE SAME

(75) Inventors: Ji-Won Kim, Cheonan-si (KR); Ik-Sun Song, Suwon-si (KR); Kyung-Ju Jeon, Cheonan-si (KR); Hak-Cheol Shin, Namyangju-si (KR); Hyoung-Wook Kim, Busan (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/574,268

(22) Filed: Oct. 6, 2009

(30) Foreign Application Priority Data
Oct. 30, 2008 (KR) 2008-107238

(51) Int. Cl. G09G 5/00; H01R 4/66

(52) U.S. Cl. 345/211; 439/92

(57) ABSTRACT

The present invention relates to a connector that includes a body and a plurality of terminals. The body extends in a first direction and includes at least one side surface coupled with an external device. The terminals include a conductive material. The terminals are arranged on the body, extend in a second direction perpendicular to the first direction, and are arranged in the first direction to receive a voltage and a control signal from the external device. At least one terminal of the terminals has a length in the second direction greater than a length of remaining terminals in the second direction, the at least one terminal to receive a ground voltage.

### CROSS REFERENCE TO RELATED APPLICATION

This application claims priority from and the benefit of Korean Patent Application No. 2008-107238, filed on Oct. 30, 2008, which is hereby incorporated by reference for all purposes as if fully set forth herein.

### BACKGROUND OF THE INVENTION

1. Field of the Invention

The present invention relates to a connector that is easily grounded, a connector assembly, and a display apparatus having the connector assembly.

2. Discussion of the Background

A liquid crystal display (LCD) typically includes a display panel to display images, a backlight assembly to supply light to the 1 display panel, and a driving circuit to apply driving signals to the display panel.

The driving circuit includes a gate driver to drive gate lines in the display panel, a data driver to drive data lines in the display panel, and a printed circuit board to supply control signals and power voltage to the gate and data drivers. The printed circuit board includes a connector assembly mounted thereon, and the printed circuit board is connected to a cable to receive the power voltage and control signals.

The connector assembly electrically connects the printed circuit board and the cable. The connector assembly may include a male connector and a female connector coupled to the male connector. When the power voltage is applied to the printed circuit board while the coupled male and female connectors are not grounded, momentary over-current may occur, which may cause the driving circuit to be damaged.

### SUMMARY OF THE INVENTION

The present invention provides a connector that may prevent circuit damage due to over-current.

The present invention also provides a connector assembly that includes the connector.

The present invention also provides a display apparatus that includes the connector assembly.

Additional features of the invention will be set forth in the description which follows, and in part will be apparent from the description, or may be learned by practice of the invention.

The present invention discloses a connector that includes a body extending in a first direction and including at least one side surface to be coupled with an external device, and a plurality of terminals including a conductive material. The terminals are arranged on the body, extend in a second direction perpendicular to the first direction, and are arranged in the first direction to receive a voltage and a control signal from the external device. At least one terminal of the terminals has a length in the second direction greater than a length of remaining terminals in the second direction, and the at least one terminal receives a ground voltage. The at least one terminal of the terminals extends longer than the remaining terminals from the at least one side surface, and divides the terminals into plural groups to prevent signal interference between the terminals.

The present invention also discloses a connector assembly that includes a first connector in which a recess is formed, and a second connector coupled with the first connector via the recess. In addition, at least one of the first connector and the second connector includes a s body extending in a first direction and including at least one side surface to be coupled with an external device, and a plurality of terminals including a conductive material. The terminals are arranged on the body, extend in a second direction perpendicular to the first direction and arranged in the first direction to receive a voltage and a control signal from the external device. In the terminals, at least one terminal has a length in the second direction greater than a length of remaining terminals in the second direction, and receives a ground voltage. The at least one terminal of the terminals extends longer than the remaining terminals from the at least one side surface, and divides the terminals into plural groups to prevent signal interference between the terminals.

The present invention also discloses a connector assembly that includes a body extending in a first direction and including at least one side surface to be coupled with an external device, and a plurality of connection pins including a conductive material. The connection pins are arranged on the body, extend in a second direction perpendicular to the first direction, and are arranged in the first direction to receive a voltage and a control signal from the external device. In addition, the connector assembly includes a signal transmission member coupled with the connection pins to transmit the voltage and the control signal, and at least one connection pin of the connection pins has a length in the second direction greater than a length of remaining connection pins in the second direction. The at least one connection pin receives a ground voltage.

The present invention also discloses a connector assembly that includes a first connector and a second connector coupled with the first connector. The first connector includes a body extending in a first direction and including at least one side surface to be coupled with an external device, and a plurality of first terminals including a conductive material. The first terminals are arranged on the body, extend in a second direction perpendicular to the first direction, and are arranged in the first direction to receive a voltage and a control signal from the external device. The second connector includes a second body in which a recess is formed, a plurality of second terminals including a conductive material, and a plurality of ground terminals. The second terminals are arranged in the recess, extend in the second direction, and are arranged in the first direction to correspond to the first terminals, respectively, and the plurality of ground terminals are spaced apart from the second terminals and arranged at an entrance of the recess to correspond to the second terminals, respectively.

The present invention discloses a display apparatus that includes a gate driver to output a gate voltage, a data driver to output a data voltage, a display panel to display an image in response to the gate voltage and the data voltage, a timing controller to apply a control signal to the gate driver and the data driver, a driving circuit board on which the timing controller is mounted, a first connector mounted on the driving circuit board and connected to the driving circuit board, the first connector comprising a recess, and a second connector coupled with the first connector via the recess. At least one of the first connector and the second connector includes a body extending in a first direction and including at least one side surface to be coupled with an external device, and a plurality of terminals including a conductive material. The terminals are arranged on the body, extend in a second direction perpendicular to the first direction, and are arranged in the first direction to receive a voltage and a control signal from the external device. In the terminals, at least one terminal has a length in the second direction greater than a length of remaining terminals in the second direction, and receives a ground voltage. The at least one terminal of the terminals extends longer than the remaining terminals from the at least one side surface, and divides the terminals into plural groups to prevent signal interference between the terminals.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view showing a display apparatus according to an exemplary embodiment of the present invention.

FIG. 2 is a perspective view showing a connector assembly according to an exemplary embodiment of the present invention.

FIG. 3A is a plan view showing a second connector shown in FIG. 2.

FIG. 3B is a partially-enlarged view showing a portion “A” shown in FIG. 3A.

FIG. 4 is a sectional view showing a coupled state of the connector assembly shown in FIG. 2.

FIG. 5A is a plan view showing a second connector according to an exemplary embodiment of the present invention.

FIG. 5B is a partially-enlarged view showing a portion “B” shown in FIG. 5B.

FIG. 6 is a perspective view showing a connector assembly according to an exemplary embodiment of the present invention.

FIG. 7 is a perspective view showing a connector assembly according to an exemplary embodiment of the present invention.

FIG. 8A is a sectional view showing a cross-sectional structure of first and second connectors shown in FIG. 7.

FIG. 8B and FIG. 8C are sectional views of the coupling process of the first and second connectors shown in FIG. 8A.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

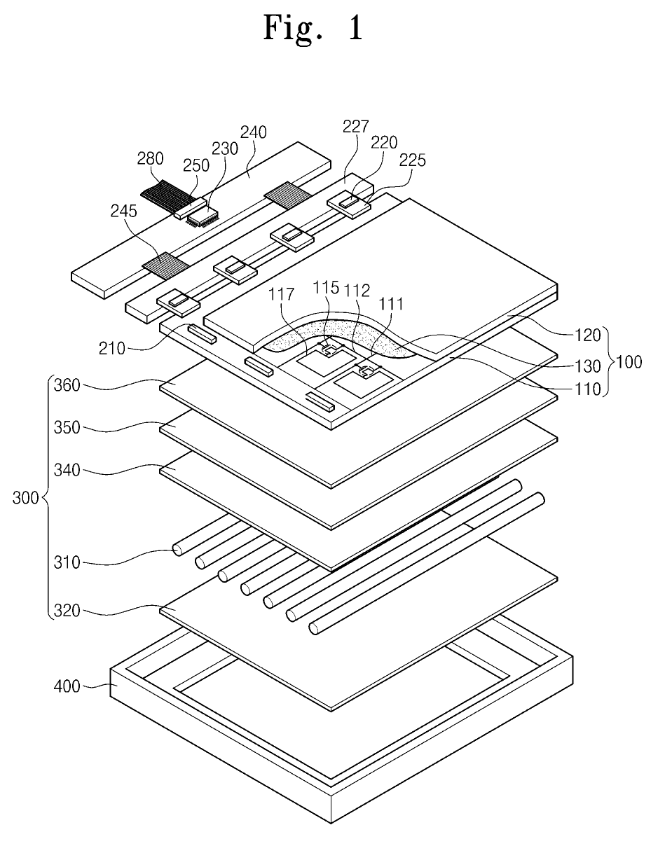

FIG. 1 is an exploded perspective view showing an exemplary embodiment of a display apparatus according to the present invention.

Referring to FIG. 1, a display apparatus includes a display panel 100, a gate driver 210, a data driver 220, a timing controller 230, a driving circuit board 240, a connector assembly 250, a backlight assembly 300, and a mold frame 400.

The display panel 100 includes a thin film transistor substrate 110, a color filter substrate 120, and a liquid crystal layer 130 interposed between the thin film transistor substrate 110 and the color filter substrate 120.

The thin film transistor substrate 110 includes gate lines 111 extending in a direction, data lines 112 extending in another direction that crosses the gate lines 111, thin film transistors 115 that are each connected to a corresponding gate line of the gate lines 111 and a corresponding data line of the data lines 112, and pixel electrodes 117 respectively connected to the thin film transistors 115. The color filter substrate 120 includes a common electrode (not shown) that forms an electric field in cooperation with the pixel electrodes 117, and a color filter (not shown) that displays colors. The liquid crystal layer 130 has a dielectric anisotropy and is aligned between the thin film transistor substrate 110 and the color filter substrate 120. The liquid crystal layer 130 adjusts light transmittance from the backlight assembly 300.

The gate driver 210 has a chip shape and may be mounted on the thin film transistor substrate 110 by a chip on glass (COG) method. The gate driver 210 applies a gate-on signal or a gate-off signal to the gate lines 111. Although not shown in FIG. 1, the gate driver 210 may be directly formed on the thin film transistor substrate 110 through a thin film process.

The data driver 220 is mounted on a first signal transmission film 225 through a tape carrier package (TCP). The data driver 220 is electrically connected to the thin film transistor substrate 110 and a source circuit board 227 through the first signal transmission film 225. The source circuit board 227 generates data signals in response to the control signals from the driving circuit board 240 and transmits the data signals to the data driver 220. The source circuit board 227 may include a gray-scale voltage generator to generate the data signals. The data driver 220 provides the data lines 113 with the data signals.

The timing controller 230 is mounted on the driving circuit board 240. The timing controller 230 applies the control signals to the gate driver 210 and the data driver 220. The timing controller 230 provides image data to the data driver 220 to display images.

The driving circuit board 240 is a printed circuit board (PCB) on which a plurality of signal transmission lines is formed. The timing controller 230, the connector assembly 250 and various electric devices are mounted on the driving circuit board 240. The driving circuit board 240 receives the power voltage and various signals from the outside, which are transmitted through the connector assembly 250. The driving circuit board 240 provides the power voltage and the various signals to the timing controller 230. The driving circuit board 240 is electrically connected to the source circuit board 227 through a second signal transmission film 245. The second signal transmission film 245 may be a flexible flat cable, and both ends thereof are connected to the driving circuit board 240 and the source circuit board 227, respectively. The control signals and the image data from the driving circuit board 240 are transmitted through the source circuit board 227 to the gate driver 210 and the data driver 220. The driving circuit board 240 applies the power voltage to the gate driver 210 and the data driver 220.

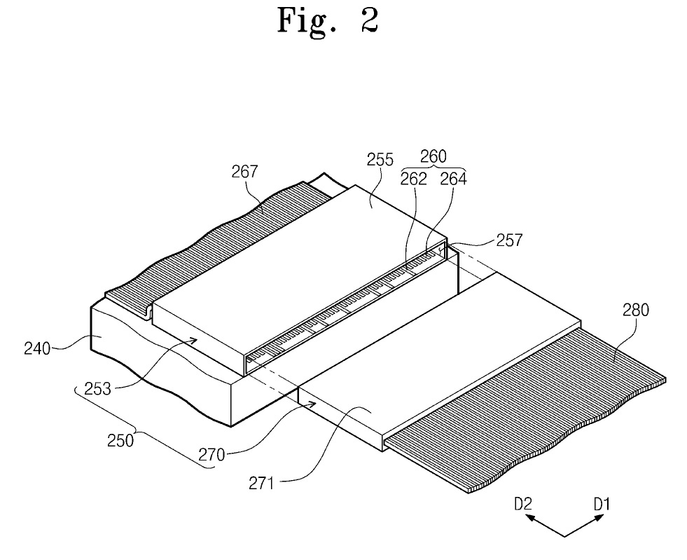

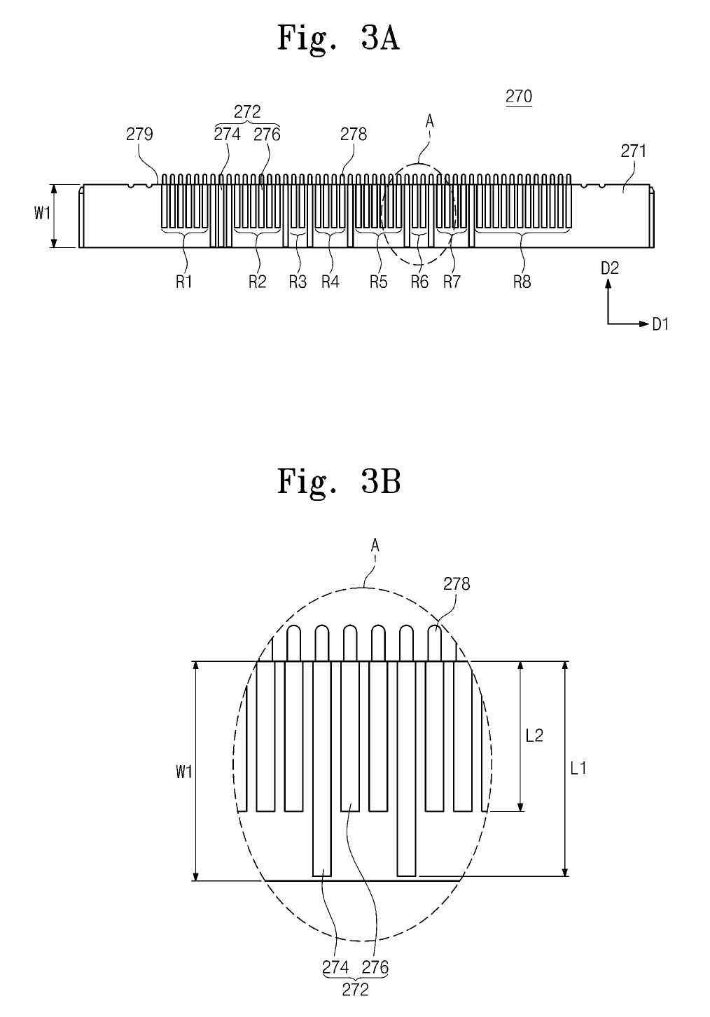

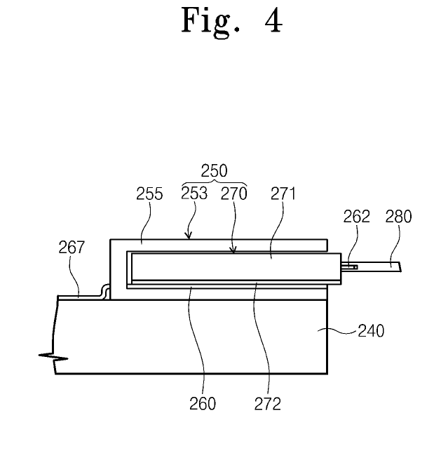

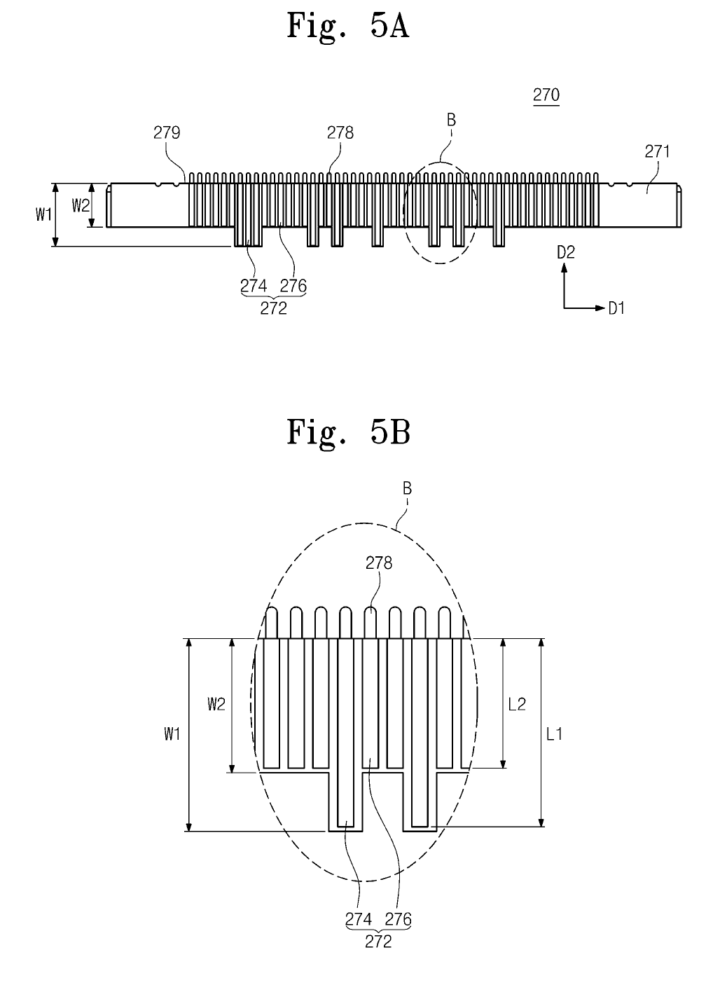

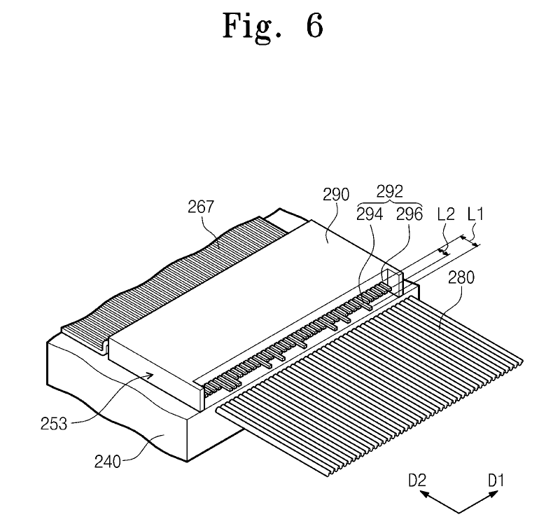

The connector assembly 250 includes a first connector mounted on the driving circuit board 240 and a second connector coupled with a signal transmission member 280. The connector assembly 250 electrically connects the driving circuit board 240 and an external system (not shown) coupled with the signal transmission member 280. Thus, the driving circuit board 240 may receive the power voltage, the clock signal, the control signal, and the image data from the external system. Although not shown in FIG. 1, the driving circuit board 240 and the source circuit board 227, which are connected to each other through the second signal transmission film 245, may be electrically connected to each other using the connector assembly 250 and the signal transmission member 280 as described above, instead of the second signal transmission film 245. A structure and function of the connector assembly 250 will be described below in detail with reference to FIG. 2, FIG. 3, FIG. 4, FIG. 5, and FIG. 6.

The backlight assembly 300 is positioned under the display panel 100 to provide the display panel 100 with light. The backlight assembly 300 includes a light source 310, a reflection sheet 320, a diffusion sheet 340, a prism sheet 350, and a protection sheet 360.

The light source 310 includes a plurality of lamps, and generates the light to be applied to the display panel 100. Each lamp is supported and held by lamp holders (not shown) positioned at both ends of each lamp, and the power voltage is applied to the lamps through the lamp holders. The reflection sheet 320 is disposed under the light source 310 and reflects the light emitted from the light source 310, which may reduce the loss of light in the display apparatus. The diffusion sheet 340 is disposed above the light source 310 and diffuses the light from the light source 310 to compensate for differences in brightness between the lamps. The prism sheet 350 condenses the light passing through the diffusion sheet 340 and provides the display panel 100 with the condensed light. The protection sheet 360 protects the prism sheet 350 from external impacts and may prevent the prism sheet 350 from being damaged.

The backlight assembly 300 shown in FIG. 1 is a direct-illumination type, where the light source 310 is disposed under the display panel 100 to provide the light to the display panel 100. However, the backlight assembly is not limited to a direct-illumination type. Alternatively, the backlight assembly 300 may be an edge-illumination type, where the light source 310 is disposed at a side portion of the display panel 100 and provides the light to the display panel 100 through a separate light guiding member.

The mold frame 400 includes an insulating material such as plastic. The mold frame 400 receives the display panel 100 and the backlight assembly 300 to protect them from external impacts.

Hereinafter, an exemplary embodiment of the connector assembly will be described in detail with reference to FIG. 2, FIG. 3, and FIG. 4. FIG. 2 is a perspective view showing an exemplary embodiment of a connector assembly according to the present invention,

FIG. 3A is a plan view showing a second connector shown in FIG. 2, FIG. 3B is a partially-enlarged view showing a portion “A” shown in FIG. 3A, and FIG. 4 is a sectional view showing a coupled state of the connector assembly shown in FIG. 2.

Referring to FIG. 2, FIG. 3A, FIG. 3B, and FIG. 4, the connector assembly 250 includes the first connector 253 mounted on the driving circuit board 240 and the second connector 270 coupled to the first connector 253.

The first connector 253 includes a first body 255 in which a recess 257 is formed and a first terminal part 260 arranged inside the recess 257.

The first body 255 includes insulating material and has a rectangular shape. A length of the first body 255 in a first direction D1 is greater than a length in a second direction D2 substantially perpendicular to the first direction D1. The recess 257 is formed in the first body 255 and recessed in the second direction D2.

The first terminal part 260 includes a plurality of terminals disposed inside the recess 257, arranged in the first direction D1, and spaced apart from each other by a uniform interval. The first terminal part 260 includes a plurality of first power terminals 262 to which a ground voltage is applied and a plurality of first signal terminals 264 to which the driving voltage, the clock signal, the control signal, and the image data are applied. The first power terminals 262 have a greater length than a length of the first signal terminals 264. Thus, the first power terminals 262 are closer to an entrance of the recess 257 in the first signal terminals 264. In addition, the length of the first power terminals 262 may be the same as the length of the first signal terminals 264. Terminals for the first terminal part 260, for example, the first power terminals 262 and first signal terminals 264, may include conductive material such as copper or copper alloy.

The first power terminals 262 may be arranged between one or more of the first signal terminals 264, which may prevent signal interference or a surge in voltage or current between the first signal terminals 264. The first power terminals 262 may divide the first signal terminals 264 into plural groups according to their functions. For example, the first signal terminals 264 are divided into the groups that include a first group R1, a second group R2, a third group R3, a fourth group R4, a fifth group R5, a sixth group R6, a seventh group R7, and an eighth group R8. Further, the first power terminals 262 may prevent display defects caused by the signal interference or the surge in voltage or current between the first signal terminals 264. The first terminal part 260 is electrically connected to signal lines 267 arranged on the driving circuit board 240.

The second connector 270 includes a second body 271 inserted into the recess 257, a second terminals part 272 arranged on a surface of the second body 271, and a plurality of connection pins 278 connected to the second terminal part 272.

The second body 271 includes insulating material and has a rectangular shape. A length of the second body 271 in the first direction D1 is greater than a length in the second direction D2. The length of the second body 271 in the first direction D1 corresponds to the length of the recess 257 in the first direction D1. The second body 271 has a first width W1 in the second direction D2, which corresponds to a depth of the recess 257.

The second terminal part 272 includes a plurality of terminals arranged on a lower surface of the second body 271 inserted into the recess 257. Particularly, the second terminal part 272 includes a plurality of second power terminals 274 to which the ground voltage is applied and a plurality of second signal terminals 276 to which the driving voltage, the clock signal, the control signal, and the image data are applied. The second power terminals 274 have a greater length than a length of the second signal terminals 276. For instance, the second power terminals 274 extend from a first side 279 of the second body 271, the first side 279 extending in a direction substantially parallel to the first direction D1, to have a first length L1, and the second signal terminals 276 extend from the first side 279 of the second body 271 to have a second length L2 shorter than the first length L1. Terminals for the second terminal part 272, for example, the second power terminals 274 and the second signal terminals 276, may include conductive material such as copper or copper alloy.

The second power terminals 274 may be arranged between one or more of the second signal terminals 276, and may prevent signal interference or a surge in voltage or current between the second signal terminals 276. The second terminal part 272 is electrically connected to the connection pins 278.

The connection pins 278 are located at the first side 279 of the second body 271 and protrude from the first side 279 of the second body 271. The connection pins 278 may include conductive material.

When the first connector 253 and the second connector 270 are coupled with each other, the first terminal part 260 and the second terminal part 272 are electrically connected to each other. When the first connector 253 and the second connector 270 are coupled with each other, the first power terminals 262 make contact with the second power terminals 274 before the first signal terminals 264 make contact with the second signal terminals 276, in order to drain unstable voltage or over-current to the ground. Accordingly, the connector assembly 250 may prevent the driving circuit board 240 from being damaged by surges in voltage or current. In addition, the connector assembly 250 drains dummy data signals remaining in the external system or the driving circuit board 240 to the ground, which may prevent a malfunction of the display panel.

The connector assembly 250 is coupled with the signal transmission member 280. The signal transmission member 280 is coupled with the connection pins 278 of the second connector 270. The signal transmission member 280 includes a flexible cable corresponding to the connection pins 278. For instance, the flexible cable may include a plurality of insertion holes to which the connection pins 278 are inserted, respectively.

Hereinafter, another exemplary embodiment of the second connector of the connector assembly will be described with reference to FIG. 5A and FIG. 5B. FIG. 5A is a plan view showing an exemplary embodiment of a second connector according to the present invention, and FIG. 5B is a partially-enlarged view showing a portion “B” shown in FIG. 5B.

Referring to FIG. 5A and FIG. 5B, a second connector 270 includes a second body 271 that has a length in a first direction D1 that is greater than a length in a second direction D2 substantially perpendicular to the first direction D1, a second terminal part 272 arranged on a surface of the second body 271 and having a plurality of terminals, and a plurality of connection pins 278 connected with the second terminal part 272.

The second terminal part 272 includes a plurality of second power terminals 274 to which the ground voltage is applied and a plurality of second signal terminals 276 to which the driving voltage, the clock signal, the control signal, and the image data are applied. The second power terminals 274 extend from a first side 279 of the second body 271, which is substantially parallel to the first direction D1, to have a first length L1, and the second signal terminals 276 extend from the first side 279 of the second body 271 to have a second length L2 less than the first length L1. Terminals for the second terminal part 272, for example, the second power terminals 274 and the second signal terminals 276, may include conductive material such as copper or copper alloy.

The second body 271 has a width corresponding to the length of the second terminal part 272 in the second direction D2. In detail, the second body 271 has a first width W1 corresponding to the first length L1 of the second power terminals 274 in an area where the second power terminals 274 are arranged, and has a second width W2 corresponding to the second length L2 of the second signal terminals 276 in an area where the second signal terminals 276 are arranged. The second body 271 may have the first width W1 in a plurality of areas according to the positions of the second power terminals 274.

Hereinafter, another exemplary embodiment of the connector assembly will be described. FIG. 6 is a perspective view showing an exemplary embodiment of a connector assembly according to the present invention. In FIG. 6, the same reference numerals denote the same elements in FIG. 2 described above, and thus detailed descriptions of the same elements will be omitted.

Referring to FIG. 6, a connector assembly includes a third body 290 mounted on the driving circuit board 240 and a plurality of connection pins 292 coupled with the third body 290.

The third body 290 includes insulating material and has a rectangular shape that has a length in a first direction D1 that is greater than a length in a second direction D2 substantially perpendicular to the first direction D1. The third body 290 insulates the connection pins 292 from each other and fixes the connection pins 292 thereto.

The connection pins 292 include a conductive material such as copper, copper alloy, or the like, and the connection pins 292 are coupled with the third body 290 such that a portion of each connection pin is exposed. The connection pins 292 include a plurality of power connection pins 294 to which the ground voltage is applied and a plurality of signal connection pins 296 to which the driving voltage, the clock signal, the control signal, and the image data are applied. The power connection pins 294 are more exposed than the signal connection pins 296. For example, the power connection pins 294 are exposed outside the third body 290 by a first length L1, and the signal connection pins 296 are exposed outside the third body 290 by a second length L2 less than the first length L1. The connection pins 292 are electrically connected to signal lines 267 arranged on the driving circuit board 240. Thus, the connection pins 292 may electrically connect the signal transmission member 280 and the signal lines 267.

The signal transmission member 280 includes a flexible cable (not shown) coupled with the connection pins 292. The signal transmission member 280 includes a plurality of insertion holes into which the connection pins 292 are inserted, respectively. The signal transmission member 280 transmits the ground voltage, the driving voltage, the clock signal, the control signal, and the image data to the connection pins 292 from exterior.

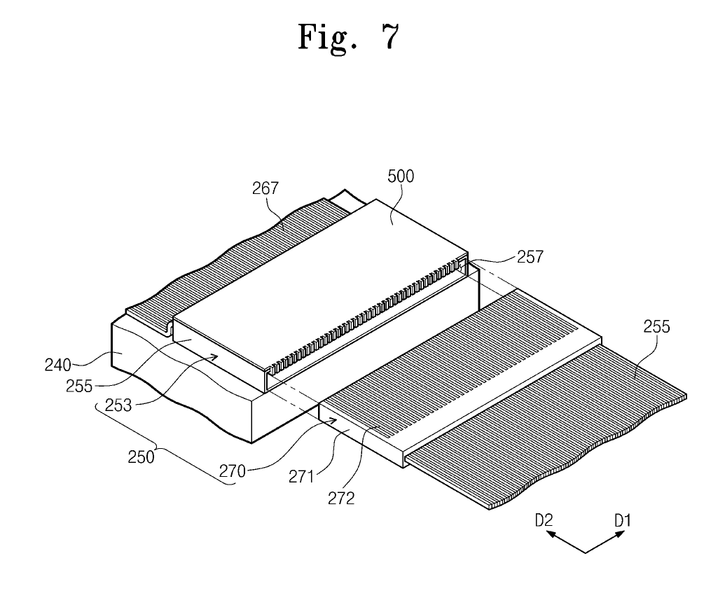

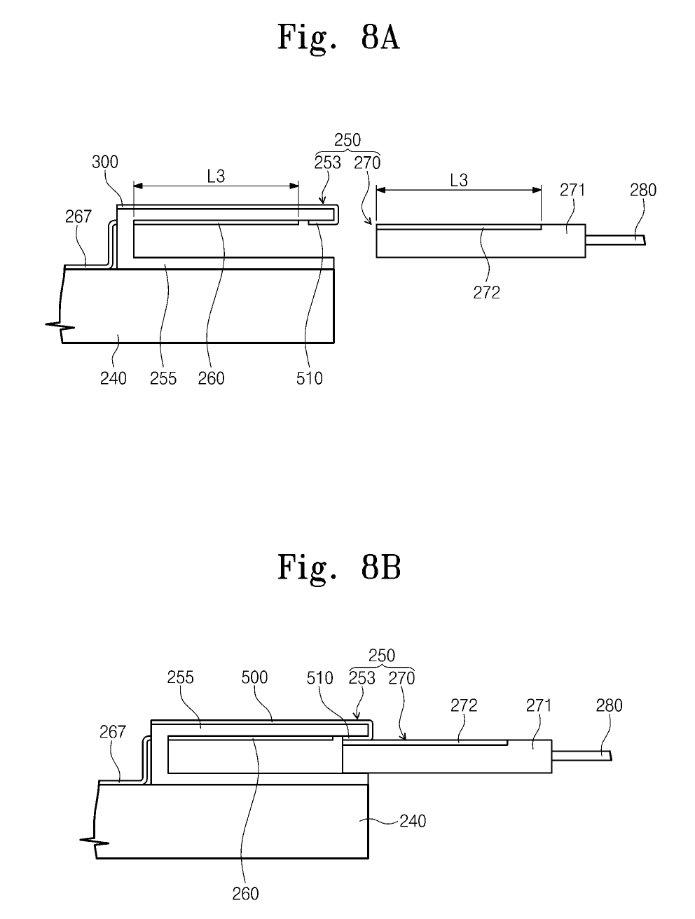

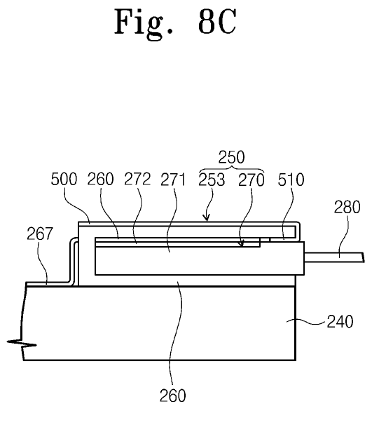

FIG. 7 is a perspective view showing another exemplary embodiment of a connector assembly according to the present invention, FIG. 8A is a sectional view showing a cross-sectional structure of first and second connectors shown in FIG. 7, and FIG. 8B and FIG. 8C are sectional views of the coupling process of the first and second connectors shown in FIG. 8A.

Referring to FIG. 7, FIG. 8A, FIG. 8B, and FIG. 8C, a connector assembly 250 includes a first connector 253 mounted on the driving circuit board 240 and a second connector 270 coupled with the first connector 253.

The first connector 253 includes a first body 255 in which a recess 257 is formed in a side surface of the first body 255, a first terminal part 260 arranged inside the recess 257, a ground member 500 coupled with a surface of the first body 255, and a ground terminal part 510 arranged inside the recess 257 and spaced apart from the first terminal part 260.

The first body 255 includes an insulating material and has a rectangular shape that has a length in a first direction D1 that is greater than a length in a second direction D2 substantially perpendicular to the first direction D1.

The first terminal part 260 includes a plurality of first power terminals (not shown) to which the ground voltage is applied and a plurality of first signal terminals (not shown) to which the driving voltage, the clock signal, the control signal, and the image data are applied. The first power terminals and the first signal terminals of the first terminals part 260 are arranged on the inner surface of the first body 255, which defines the recess 257. In addition, the terminals of the first terminal part 260 extend in the second direction D2 and are arranged in the first direction D1 such that the terminals of the first terminal part 260 are spaced apart from each other by a uniform distance. The terminals of the first terminal part 260 have a third length L3.

The ground member 500 includes a conductive material and is arranged on at least one outer surface of the first body 255, so that the ground member 500 may ground static electricity occurring when the first and second connectors 253 and 270 are coupled with each other.

The ground terminal part 510 is arranged at an entrance of the recess 257 to be spaced apart from the first terminal part 260. The ground terminal part 510 includes a plurality of ground terminals, which are spaced apart from the first power terminals and the first signal terminals. The ground terminal part 510 is connected to the ground member 500 to form a ground path. The ground terminal part 510 conducts static electricity flowing from the exterior so that the static electricity does not flow into the first terminal part 260. Thus, the ground terminal part 510 may prevent damage of the first terminal part 260 and the driving circuit board 240.

The ground terminal part 510 may be integrally formed with the ground member 500. That is, the ground terminal part 510 may be formed by extending the end portions of the ground member 500 so that the end portions of the ground member 500 correspond to the terminals of the first terminal part 260. In addition, the ground terminal part 510 extends from the ground member 500 and wraps around the end portion of the first body 255, so that the ground terminal part 510 is disposed adjacent to the entrance of the recess 257.

The second connector 270 includes a second body 271 inserted into the recess 257 and a second terminal part 272 arranged on a surface of the second body 271.

The second body 271 includes insulating material and has a rectangular shape that has a length in the first direction Dl that corresponds to the recess 257.

The second terminal part 272 includes conductive material. The second terminal part 272 includes a plurality of terminals corresponding to the terminals of the first terminal part 260, which extend in the second direction D2 and is arranged in the first direction D1 to be spaced apart from each other by a uniform distance. The second terminal part 272 includes a plurality of second power terminals to which the ground voltage is applied and a plurality of second signal terminals to which the driving voltage, the clock signal, the control signal, and the image data are applied.

As shown in FIG. 8B, when the second connector 270 is coupled with the first connector 253, the second terminal part 272 makes contact with the ground terminal part 510 to form a ground path, thereby grounding static electricity. Then, as shown in FIG. 8C, the second terminal part 272 makes contact with the first terminal part 260 to transmit the driving voltage, the clock signal, the control signal, and the image data to the first connector 253. The second terminal part 272 has a third length L3 corresponding to the first terminal part 260.

Although not shown in the figures, if the second terminal part 272 extends over the third length L3 to make contact with the ground terminal part 510, the various signals from the exterior and the image data may be grounded.

However, the length of the second terminal part 272 may have other lengths besides the third length L3 as long as the second terminal part 272 does not simultaneously contact the first terminal part 260 and the ground terminal part 510 when the second connector 270 is coupled with the first connector 253.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A connector, comprising:
a body extending in a first direction and comprising at least one side surface to be coupled with an external device; and
a plurality of terminals comprising a conductive material, the terminals being arranged on the body, extending in a second direction substantially perpendicular to the first direction, and arranged in the first direction to receive a voltage and a control signal from the external device,
wherein at least one terminal of the terminals has a length in the second direction greater than a length of remaining terminals in the second direction, and the at least one terminal receives a ground voltage.

2. The connector of claim 1, wherein the at least one terminal of the terminals extends longer than the remaining terminals from the at least one side surface, and divides the terminals into plural groups to prevent signal interference between the terminals.

3. The connector of claim 1, wherein the body has a width in the second direction, which is at least as wide as the length of the at least one terminal.

4. The connector of claim 1, wherein the body has a first width in the second direction, which is at least as wide as the length of the at least one terminal in an area where the at least one terminal is arranged, and has a second width in the second direction, which is at least as wide as the length of the remaining terminals in an area where the remaining terminals are arranged.

5. A connector assembly, comprising:
a first connector in which a recess is formed: and a second connector coupled with the first connector via the recess, wherein at least one of the first connector and the second connector comprises:
a body extending in a first direction and comprising at least one side surface to be coupled with an external device; and
a plurality of terminals comprising a conductive material, the terminals being arranged on the body, extending in a second direction substantially perpendicular to the first direction, and arranged in the first direction to receive a voltage and a control signal from the external device,
wherein at least one terminal of the terminals has a length in the second direction greater than a length of remaining terminals in the second direction, and the at least one terminal receives a ground voltage.

6. The connector assembly of claim 5, wherein the at least one terminal of the first terminals extends longer than the remaining terminals from the at least one side surface, and divides the terminals into plural groups to prevent signal interference between the terminals.

7. The connector assembly of claim 5, wherein the body has a width in the second direction, which is at least as wide as the length of the at least one terminal.

8. The connector assembly of claim 5, wherein the body has a first width in the second direction, which is at least as wide as the length of the at least one terminal in an area where the at least one terminal is arranged, and has a second width in the second direction, which is at least as wide as the length of the remaining terminals in an area where the remaining terminals are arranged.

9. The connector assembly of claim 5, further comprising a signal transmission member coupled with the second connector, the signal transmission member to transmit the voltage and the control signal.

10. A connector assembly, comprising:
a body extending in a first direction and comprising at least one side surface to be coupled with an external device;
a plurality of connection pins comprising a conductive material, the connection pins being arranged at a side surface of the body, extending in a second direction substantially perpendicular to the first direction, and arranged in the first direction to receive a voltage and a control signal from the external device; and
a signal transmission member coupled with the connection pins to transmit the voltage and the control signal,
wherein at least one connection pin of the connection pins has a length in the second ii direction greater than a length of remaining connection pins in the second direction, and the at least one connection pin receives a ground voltage.

11. The connector assembly of claim 10, wherein the signal transmission member comprises a flexible cable coupled with the connection pins, and the flexible cable comprises a plurality of insertion holes to which the connection pins are inserted, respectively.

12. A connector assembly, comprising:
a first connector comprising:
a first body extending in a first direction and comprising at least one side surface to be coupled with an external device; and
a plurality of first terminals comprising a conductive material, the first terminals being arranged on the body, extending in a second direction substantially perpendicular to the first direction, and arranged in the first direction to receive a voltage and a control signal from the external device; and
a second connector coupled with the first connector, the second connector comprising:
a second body in which a recess is formed; and
a plurality of second terminals comprising a conductive material, the second terminals being arranged in the recess, extending in the second direction, and arranged in the first direction to correspond to the first terminals, respectively, and a plurality of ground terminals spaced apart from the second terminals and arranged at an entrance of the recess to correspond to the second terminals, respectively.

13. The connector assembly of claim 12, wherein the second connector further comprises a ground member comprising a conductive material, the ground member is arranged on the second body, and the ground member to be connected to the ground terminals.

14. The connector assembly of claim 13, wherein the ground terminals are integrally formed with the ground member.

15. The connector assembly of claim 13, wherein the first terminals have a length corresponding to a length of the second terminals.

16. A display apparatus, comprising:
a gate driver to output a gate voltage;
a data driver to output a data voltage;
a display panel to display an image in response to the gate voltage and the data voltage;
a timing controller to apply a control signal to the gate driver and the data driver;
a driving circuit board on which the timing controller is mounted;
a first connector mounted on the driving circuit board and connected to the driving circuit board, the first connector in which a recess is formed; and
a second connector coupled with the first connector via the recess,
wherein at least one of the first connector and the second connector comprises:
a body extending in a first direction and comprising at least one side surface to be coupled with an external device; and
a plurality of terminals comprising a conductive material, the terminals being arranged on the body, extending in a second direction perpendicular to the first direction and arranged in the first direction to receive a voltage and a control signal from the external device, wherein at least one terminal has a length in the second direction greater than a length of remaining terminals in the second direction, and the at least one terminal receives a ground voltage.

17. The display apparatus of claim 16, wherein the at least one terminal of the terminals extends longer than the remaining terminals from the at least one side surface, and divides the terminals into plural groups to prevent signal interference between the terminals.

18. The display apparatus of claim 16, wherein the body has a width at least as wide as the length of the at least one terminal in the second direction.

19. The display apparatus of claim 16, wherein the body has a first width in the second direction, which is at least as wide as the length of the at least one terminal in an area where the at least one terminal is arranged, and has a second width in the second direction, which is at least as wide as the length of the remaining terminals in an area where the remaining terminals are arranged.

20. The display apparatus of claim 16, further comprising a signal transmission member coupled with the second connector, the signal transmission member to transmit the voltage and the control signal.
